(19) United States
(12) Patent Application Publication
(10) Pub. No.: US 2003/0058176 A1
(43) Pub. Date: Mar. 27, 2003

(54) Miniature dielectric-loaded antenna resonator

(76) Inventors: Don Keilen, Sparks, NV (US); Enrique Ayala, Watsonville, CA (US)

Correspondence Address: Fulbright & Jaworski L.L.P., Suite 4850, 225 South Sixth Street, Minneapolis, MN, 55402-4320, US

(21) Appl. No.: 10/198,280

(22) Filed: Jul. 5, 2002

Related U.S. Application Data
(60) Provisional application No. 60/303,223, filed on Jul. 5, 2001.

(51) Int. Cl. H01Q 1/24

(52) U.S. Cl. 343/702; 343/700 MS

(57) ABSTRACT

An antenna resonator element which couples to a ground plane and provides single or multiple linear polarizations and gain on the order of +2 dBi. One preferred shape of the resonator is a cube having dimensions 0.06 wavelength per side. The resonator's mechanical design makes it suitable for installation in small wireless communications devices and equipment, and suitable for low cost high volume manufacture.

### CROSS REFERENCE TO RELATED APPLICATION

This application claims the benefit of priority of U.S. Ser. No. 06/303,223, filed Jul. 5, 2001, pursuant to 35 U.S.C. §119, and the entire disclosure of which is incorporated in its entirety by reference herein.

### BACKGROUND OF THE INVENTION

The size of wireless communications devices (WCD's) has and continues to be reduced, in part due to the miniaturization of semiconductors and associated circuitry. All WCD's require an antenna, which ideally is compatible in size. WCD's have used external whip antennas, which are currently being replaced by innovative new internal antennas. The PIFA resonator and patch are two examples, however they are much larger than the resonator of the present invention.

Examples of applications for small, efficient, and low cost internal antennas are Bluetooth-enabled devices, cell phones, pagers, personal digital assistants (PDA's), and handheld and other computers and their peripherals. These products are now commodities, and therefore must be cost effective in their manufacture in order to capture market share.

### SUMMARY OF THE INVENTION

The antenna resonator of the present invention consists of an arranged plurality of conductive elements disposed relative to a ground plane of a wireless communications device. In one embodiment the plurality of conductive elements may encompass a dielectric block with conductors arranged on its surfaces so as to provide the desired electrical characteristics when connected to the ground plane. The dielectric block may be a cube or may have other shapes. The ground plane can assume a variety of shapes, however it must have at least one major dimension of one-quarter wavelength. The ground traces of a printed wiring board (PWB) within or on a WCD may provide the ground plane for the resonator.

One preferred location for the resonator is at a corner of the ground plane. This preferred configuration yields nearly hemispherical response to two orthogonal linear polarizations, which response is particularly useful for communications links subject to multipath. Another preferred location is along one edge of the ground plane. The VSWR bandwidth and radiation patterns are optimum for these configurations, and are somewhat degraded when the resonator is centrally located on a ground plane.

One preferred dielectric material for use with the resonator is DOW QUESTRA®, a fiberglass-filled plastic. This material has a dielectric constant of 3, a low loss tangent, and may be injection molded. Other low loss dielectric materials with dielectric constants in the range 1-35 may be used. The conductors on the surfaces of the dielectric may be provided by a single piece of stamped metal which is formed to the required shape and snapped onto the dielectric. Another embodiment of the resonator has the conductors on the surfaces of the dielectric provided by a two-shot molding process.

The resonator has one electrical connection to the ground plane, near which an unbalanced transmission line is connected. The feed system is a shunt feed system, and results in a useable bandwidth of 6-10%. A slot feature in the top surface conductor serves as an impedance matching device. Unbalanced transmission lines such as coaxial, microstrip, or stipline may be used to feed the antenna formed by the resonator and ground plane.

The antenna resonator of the present invention may be manufactured in high volume by currently available means, and at low cost. Further, the resonator is lightweight and requires a very small volume, allowing it to be installed within or on any WCD without impacting its size or weight. The resonator is suitable for surface mounting, which makes it ideal for machine installation on a PWB.

### BRIEF DESCRIPTION OF THE DRAWINGS

FIG. 1 shows a cutaway perspective view of a WCD including a resonator antenna device according to the present invention.

FIG. 2 shows a perspective view of one embodiment of the resonator antenna device of the present invention.

FIG. 3 shows a plan and four elevation views of one embodiment of the resonator antenna device of the present invention.

FIG. 4 shows the VSWR for the embodiment of FIGS. 2 and 3 with dimensions of FIG. 4, over the 2.4-2.5 GHz band.

### DETAILED DESCRIPTION OF THE DRAWINGS

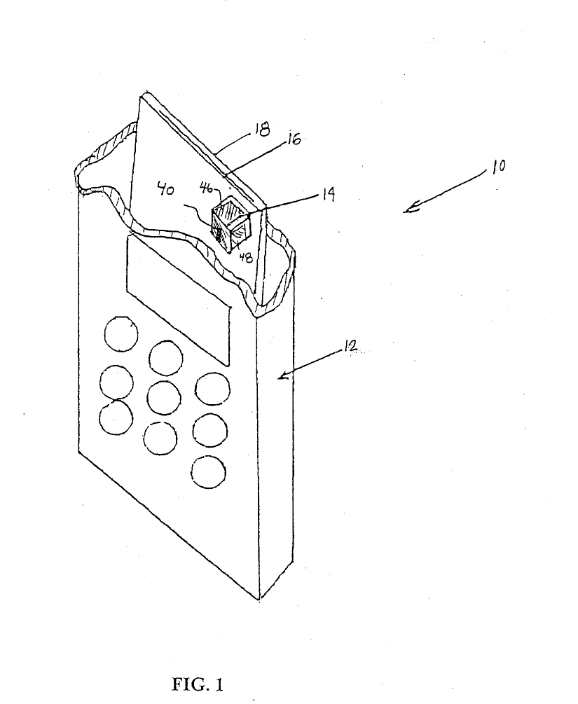

Referring to FIG. 1, a WCD 10 is shown with the top portion of the housing 12 cut away to reveal the resonator antenna device 14. A ground plane 16 is shown, which may be provided by the ground traces of the WCD's printed wiring board 18. As illustrated, antenna resonator 14 of this embodiment of the present invention is shown installed on ground plane 16 at an upper corner during normal operation of the WCD 10. This position represents only one preferred embodiment of the antenna of the present invention as other resonator 14 positions may also be practicable. Resonator 14 may be installed on the other face of ground plane 16, and/or at other locations on ground plane 16 to form other embodiments. Resonator 14 may include a dielectric element 20 supporting a plurality of conductors as described hereinafter.

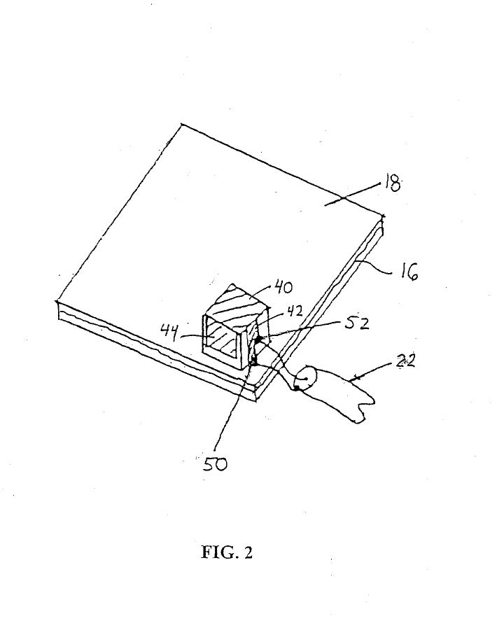

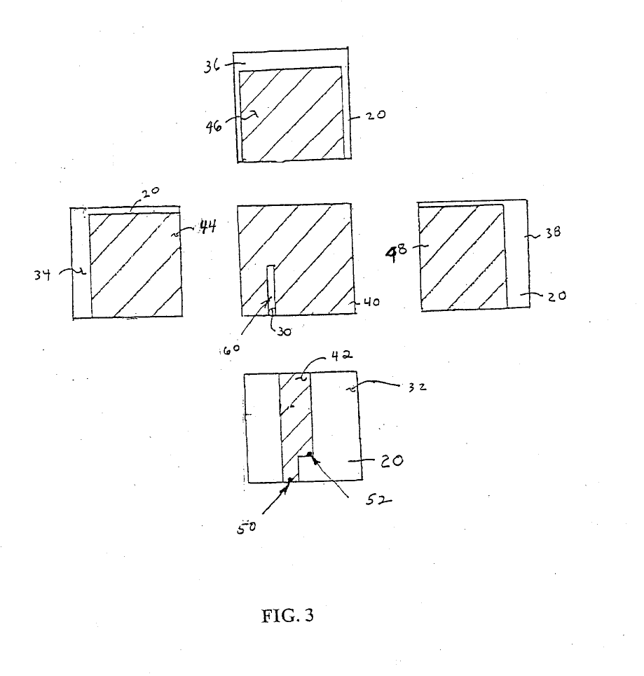

Referring to FIG. 2 a perspective view of one preferred embodiment of an antenna resonator 14 of the present invention is shown. FIG. 3 illustrates the different faces of resonator 14 of FIG. 2. Resonator 14 is shown installed on ground plane 16 to form the antenna. Resonator 14 includes a top face 30 which is generally parallel with ground plane 16 and a plurality of side faces 32, 34, 36, and 38. Each face 30, 32, 34, 36, and 38 has an associated conductor 40, 42, 44, 46, and 48 disposed thereupon. A coaxial feedline 20 is connected to conductor 42 on face 32 of resonator 14. Conductor 42 is also connected to ground plane 16 at a location proximate to the signal line connection. The outer shield of coax line 22 is connected to conductor 42 at location 50. The center conductor of coax line 22 is connected to the conductor 42 at location 52 to form a shunt feed system. The exact position of location 52 may be determined empirically by adjusting for minimum VSWR over the frequency range of interest. A coax line 22 is shown here as the feed line, however a microstrip or other suitable type of transmission line may be used to feed resonator 14. Resonator 14 is shown near a corner of ground plane 16, however it may also be placed along one edge in another preferred embodiment, or elsewhere on ground plane 16.

Resonator 14 includes a dielectric element 20. One preferred dielectric material for dielectric element 20 is DOW QUESTRA®, a fiberglass-filled plastic. This material has a dielectric constant of 3, a low loss tangent, and may be injection molded. Other low loss dielectric materials with dielectric constants in the range 1-35 may be used. Conductors 40, 42, 44, 46, 48 on the surfaces of the dielectric 20 may be provided by a single piece of stamped metal which is formed to the required shape and snapped onto the dielectric. Another embodiment of the resonator 14 has the conductors on the surfaces of the dielectric provided by a two-shot molding process. Yet another embodiment may have the conductors 40, 42, 44, 46, 48 defined by conductive platings on a dielectric substrate.

Top conductor 40 of resonator 14 includes a slot structure 60. A length and width of slot 60 is adjusted for optimum VSWR over the frequency range of interest. An edge of slot 60 is aligned with an edge of conductor 42. The following conductor pairs are in electrical contact over at least a portion of the common edge; 40-42, 40-44, 40-6, 40-48. One particular embodiment of the resonator 14 of the present invention is suitable for operation over the frequency range of 2.4-2.5 GHz. Resonator 14 may be a cube having face dimensions of 0.27 inch square. The dimension 0.27 inch represents 0.06 wavelength at 2.45 GHz, which is much smaller than major dimensions required for other types of resonators or antennas.

In alternative embodiments of the present invention a conductive element (not shown) separate from ground plane 16 on printed wiring board 18 may be utilized to practice the present invention.

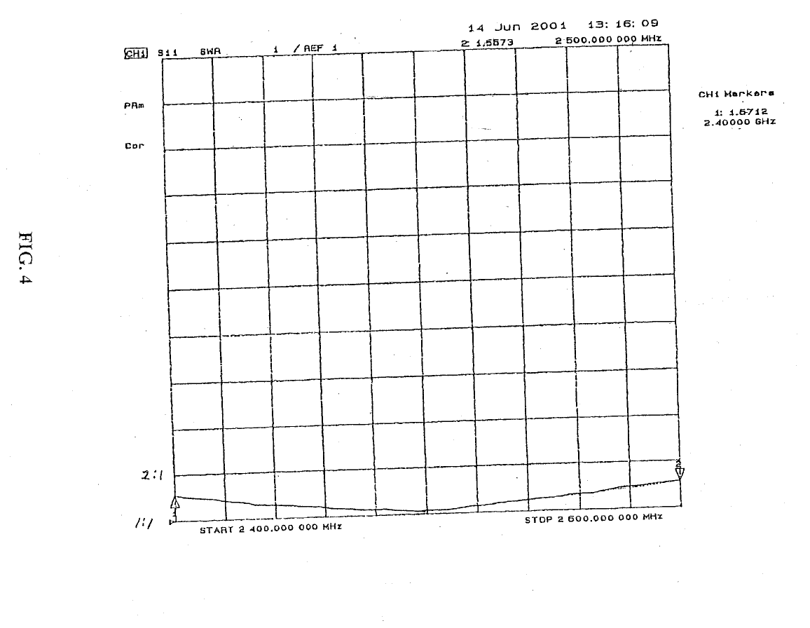

Referring to FIG. 4, a plot of VSWR vs. frequency is shown for 2.4-2.5 GHz, for the embodiment of the present invention shown in FIGS. 2 and 3, with ground plane 16 having major dimensions 2×2 inches.

Although particular embodiments of the invention have been illustrated in the accompanying Drawings and described in the foregoing Detailed Description, it will be understood that the invention is not limited only to the embodiments disclosed, but is intended to embrace any alternatives, equivalents, or modifications falling within the scope of the invention as defined by the following claims.

1. An antenna assembly for a wireless communications device comprising:
a conductive ground plane disposed within the wireless communications device;
a dielectric element proximate the ground plane; and
a conductive resonator element substantially encompassing the dielectric element, said resonator element including a top face element having an elongate slot defined thereupon, and a plurality of side face elements, each being electrically coupled to the top face element along a portion of a common edge, and one of the plurality of side face elements being operatively coupled to the ground plane and to a signal line for operation.

2. An antenna assembly of claim 1, wherein the conductive ground plane is provided by ground traces disposed upon a printed wiring board, said ground traces being utilized by electronic components of the wireless communications devices.

3. An antenna assembly of claim 1, wherein the dielectric element is a rectangular solid element.

4. An antenna assembly of claim 3, wherein the dielectric element is a substantially cubic.

5. An antenna assembly of claim 1, wherein the top face element of the conductive resonator extends to four edges of the dielectric element.

6. An antenna assembly of claim 5, wherein each of the plurality of side face elements extends to an edge in common with a different one of the plurality of side face elements.

7. An antenna assembly of claim 1, wherein the elongate slot extends inwardly from an edge of the top face element.

8. An antenna assembly of claim 7, wherein the elongate slot extends from an edge of the top face element which is coupled to the one of the plurality of side face elements being operatively coupled to the ground plane and the signal line.

9. An antenna assembly of claim 1, wherein the dielectric element is disposed proximate a corner of the printed wiring board.

10. An antenna assembly of claim 9, wherein the dielectric element is disposed proximate an upper corner of the printed wiring board during intended use of the wireless communications device.

11. An antenna assembly for a wireless communications device having a ground plane and a signal line, said antenna assembly comprising:
a ground plane; and
a conductive resonator element disposed in relation to the ground plane, said resonator element including a top conductive element having an elongate slot defined thereupon, and a plurality of side conductive elements, each being electrically coupled to the top conductive element along a portion of a common edge, and one of the plurality of side conductive elements being operatively coupled to the ground plane and to the signal line for operation.

12. An antenna assembly of claim 11, wherein the conductive resonator element substantially encompasses a dielectric element.

13. An antenna assembly of claim 11, wherein each of the plurality of side conductive elements extends to an edge in common with a different one of the plurality of side conductive elements.

14. An antenna assembly of claim 11, wherein the elongate slot extends inwardly from an edge of the top conductive element.

15. An antenna assembly of claim 14, wherein the elongate slot extends from an edge of the top conductive element which is coupled to the one of the plurality of side conductive elements being operatively coupled to the ground plane and the signal line.

16. An antenna assembly of claim 11, wherein the resonator element is disposed proximate to a corner of the printed wiring board.

17. An antenna assembly of claim 16, wherein the resonator element is disposed proximate an upper corner of the printed wiring board during intended use of the wireless communications device.

18. An antenna assembly for a wireless communications device having a ground plane and a signal line, said antenna assembly comprising:
a conductive resonator element disposed in relation to the ground plane, said resonator element including a top conductive element having an elongate slot defined thereupon, and a plurality of side conductive elements, each being electrically coupled to the top element along a portion of a common edge; and
a shunt feed structure wherein the signal line is coupled to one of the plurality of side conductive elements at a signal line connection location, said one of the plurality of side conductive also being coupled to the ground to the ground plane at a location proximate to the signal line connection location.

19. An antenna assembly of claim 18, wherein each of the plurality of side conductive elements extends to an edge in common with a different one of the plurality of side conductive elements.

20. An antenna assembly of claim 18, wherein the elongate slot extends inwardly from an edge of the top conductive element.
